(19) United States
(12) Patent Application Publication
(10) Pub. No.: US 2023/0061964 A1
(43) Pub. Date: Mar. 2, 2023

(54) CONSTRUCTION SUPPORT DEVICE

(71) Applicant: Howard Charles Roman, III, Pennsburg, PA (US)

(72) Inventor: Howard Charles Roman, III, Pennsburg, PA (US)

(21) Appl. No.: 17/893,910

(22) Filed: Aug. 23, 2022

Related U.S. Application Data
(60) Provisional application No. 63/236,422, filed on Aug. 24, 2021.

(51) Int. Cl. F16B 5/06; A63F 9/06

(52) U.S. Cl. CPC F16B 5/0607; A63F 9/0602; F16B 2005/0678

(57) ABSTRACT

A construction support device is disclosed for support and assembly of planar members into complex structures. A construction support device can comprise a first and second unit that are separable where each support unit comprises a plurality of sinuate grooves between a plurality of sections with sinuate edges. The sections are flexible about a center to increase the width of the sinuate grooves to receive greater thickness of planar members. A cubic embodiment with flat outer surfaces and a spheric embodiment with round outer surfaces are disclosed.

### RELATED APPLICATIONS

This application claims the benefit of U.S. Provisional Application No. 63/236,422 filed on Aug. 24, 2021, the disclosure of which is incorporated herein in its entirety.

### BACKGROUND OF THE INVENTION

### Field of the Invention

The present general inventive concept is directed to an apparatus and method for using a construction support device that aids a user in assembling structures from planar members including playing cards.

### Description of the Related Art

The prior art includes a number of construction aids for use in modeling, aids to hobbyists, and toys for children. A number of devices and kits are sold commercially that provide for the ease of construction of various members. Professional card construction is difficult, but also well known, and skilled persons can construct a “house of cards” or “tower of cards” and other impressive structures. For most people, this level of construction from planar members such as playing cards is out of reach.

A number of building and construction toys and products have been disclosed and marketed. Such toys, games, and puzzles activities or products are advantageous because they tend to increase manual dexterity, improve hand-eye coordination, and exercise the imagination of an individual. Examples of such games include TINKER TOYS™, LEGO™, ERECTOR™ sets, K'NEX™, and more. When used, these product offerings differ in materials and components used, and also in the skill and ability required of a user to achieve results. These results range from basic beginner interaction to complete mastery of the activity.

One of the most challenging building activities is that of card stacking. Card stacking can be employed to build various small and large horizontal and vertical structures, such as a house of cards or card tower, using a variety of different methods and techniques of configuring, arranging, and stacking cards. These methods and techniques relate either specifically to how cards are actually positioned, arranged and configured relative to each other (a pyramid or triangle vs. a 4-card offset perpendicular T-shaped block cell or expanded grid) or, more broadly, to whether assistive support elements are used throughout either a portion or the entirety of a card structure.

Card structures can be stacked using either purely freestanding methods, by using purely assistive methods or by using a combination of both freestanding and assistive methods. In a purely freestanding method of card stacking, the integrity of a structure relies on the application of the same mechanical physics, civil and structural engineering and design concepts used by engineers to construct large-size, real-world, structures, such as skyscrapers and bridges.

In a purely assistive method of card stacking, a card structure is constructed by either bending, folding, joining, notching slits in the cards themselves or otherwise using an outside external assistive support element, such as an adhesive product like tape, glue, or a connector construction support device product.

Traditionally, card structures have been constructed using a triangle or pyramid method, insofar as the actual configuration and arrangement of planar members relative to each other is concerned. In more recent years, however, a 4-card cell and expanded grid method and technique has been promulgated and made popular by elite professional card stackers. In this method, each connecting card offsets each other, intersecting a contacted card member perpendicularly creating a “T” formation with each card also positioned perpendicularly to a building surface. This resultant basic card stacking structure foundational unit formed has been deemed by professional card stackers as being a superior method to the triangle or pyramid method due to the inherent structural integrity, strength, support, and stability provided to the entirety of a structure. The superiority of this 4-card cell and grid-like arrangement was determined after being tested to support up to 660 pounds per square foot. This method or technique of card stacking including edge-to face surface contact also allows for a wide range of different structures to be built.

A number of challenges are associated with card stacking. While playing cards are the most commonly used, any planar stackable member can be used, including game cards, trading cards, collector's cards, business cards, index cards, recipe cards, swap-cards, or any other type of card used for any other purpose. Due to their generally low cost of material, mass production, and readily accessible nature of planar stackable members of all sorts, households around the world are generally in no short supply of them. Among several obstacles to success, card structures built exclusively with a freestanding method technique of card stacking rely on a combination of balance and friction in order to effectively stay upright. In addition, the surface foundations by which card structures are built upon vary and are subject to builder home and lifestyle circumstance and availability. Carpeted surfaces, for example, can provide generally flimsy and unsteady surfaces, that are often used, but are very unreliable for building purposes due to their give, pliability, and lack of firmness for support.

While these obstacles to success can provide a formidable challenge that is embraced by some, the act of building large and impressive structures by a freestanding card stacking method is a largely frustrating endeavor—placing it largely out of reach for most children and adults to achieve. Evidence of this is observed through the establishment of an entire industry of elite professional card stackers who, through hours of practice and experience, are able to achieve building some of the most spectacular structures.

Another challenge is that whether a card structure is built with freestanding methods or by use of assistive support methods, there presently exists no exacting step-by-step instruction manual such that specific structures—whether of real-world or of fictional or fantasy world structures, from books and movies—can be built, whether horizontally, vertically, or a combination of both.

Another challenge that exists is related to the structural engineering concept or principle of foundations. There presently exists no solution by which to establish a supportive, even, stable surface foundation for the expressed purpose and application to the art of planar member stacking or building structures out of cards by increasing structural support and stability.

Without assistance, building large, spectacular structures with cards like professionals do requires a significant combination of skill, experience, determination, and patience—making it a largely out of reach endeavor for most people. Currently there exists no solution for achieving the building of a structure out of cards that is accessible to beginners, utilizing a fully assistive support method. Card structures built with only planar members or cards rely on balance and friction to stay upright and are therefore easily undone. Because of the inherent difficulty in card stacking, it is typically practiced by professional card stackers. Card stacking from the pros is inherently impermanent. While this adds to the awe of the structure, it is a barrier to beginners and children.

Numerous attempts have been made to increase the ease and accessibility of stacking cards and aid in the retention or permanence of the structure once built. One prior attempt is the product Card Clips. The product includes several different connection types or clips. Clip types include linear connectors, angled connectors, and cross shaped connectors. The clips do not provide for close connection of the planar members as the receiving portion of the connectors does not reach the center of the connector. Attached planar members are spaced apart. The connectors must be selected for the connection type and are limited as to the number of planar members that can be received and retained by the connectors. Connections are limited such as 180 degree connection, 90 degree connection with a T shaped or X shaped connector, or at an acute or obtuse angle with an angled connector. The clips do not add substantial weight or inertia to the structure. In addition, no edge-to-face surface contact or connection can be made between planar members, either such as that the long or short edge face of one planar member can be positioned to make contact or connection with the long or short face of another planar member.

U.S. Pat. No. 9,220,994 to Murphy et al. discloses a product sold as Skallops. This product provides a fan shaped connector, made of birch plywood, that allows planar members to be attached at various angles, with slots for card insertion every 15 degrees. It does not provide for sequential addition of planar members at right angles to construct a structure. The openings for receiving a planar member are arranged along an arcuate edge of the card-holding portion. The plurality of slits are configured to receive a card that is 0.01 inches or 0.012 inches thick. Retention of multiple cards is not disclosed, and connector openings are only adequate to accommodate insertion of 1 playing card of standard thickness to the entire depth of the opening slots of the connector. Insertion of additional cards into an opening slot meet great resistance, potentially damaging the planar edge and surfaces of the planar member or playing card.

Another extant disclosure provides a connector for playing cards and the like which comprises a thin tubular shell divided into longitudinal slats by thin slits that have external chamfers to facilitate the entry of cards therein. Application WO9707489 by Jankovic discloses “a thin, substantially hollow tubular shell.” The device of the invention is hollow and light in weight. An inserted card is intended to engage two slits on opposite ends of a tube for retention.

At the heart of building these structures is the professional card stacker's most widely preferred technique of stacking cards—the 4-card expanded grid in which each connecting card offsets each other, bisecting each other perpendicularly, like a “T” formation and forming a basic card stacking foundational unit. In U.S. Pat. No. 9,022,389 to Berg for Grooved Supporting Member for Assisting in the Construction of a Card Structure, a starting base is disclosed to retain cards in a block formation for starting a card structure. This device does not provide support or assistance for building additional cards upward.

Another attempted solution is that of playing cards that comprise slits along all four perimeter edges of a playing card. This allows the cards to be interleaved rather than stacked. The product is sold under the name Custom Connect-a-Card.

Professional card stackers detail how they oftentimes use multiple cards, one layered on top of another, and place them in various locations throughout the entirety of a card structure for no other reason than to add weight. The reason for doing this is because adding weight inherently adds strength, support, and stability to a structure. A majority of attempted solutions for constructing cards requires edge-to-edge card contact.

At present, there is a need for a configurable, supportive, even, stable card stacking base foundation tray or mat surface and construction support connectors to simultaneously provide a stable surface foundation for building and serve as a visual guide to assist in the stacking of cards into vertical and horizontal structures.

What is needed is a construction support device suited to receive multiple layered planar members to increase strength and stability.

What is needed is a device that aids in the retention and display of planar members in a continuous visible surface.

### SUMMARY OF THE INVENTION

It is an aspect of the invention to provide a device for creating a 4-card grid, in which each connecting card bisects another card in a “T” formation. It is a further aspect of the invention to provide a construction support device that contributes strength, stability, and support to a card structure that can be assembled and disassembled, and persists for long term presentation or display.

It is an aspect of the present invention to provide a support device for releasably joining and retaining planar stackable members to assemble a house of cards or other wide variety of structures utilizing playing cards, index cards, or related elements of any suitable dimension. The construction support device can be cubic or spherical in shape and can be weighted. The present invention provides a construction support device comprising a plurality of sections projecting radially outward from a solid center, the plurality of sections each comprise sinuate edges; and the plurality of sections are spaced apart from adjacent sections to create a plurality of sinuate grooves configured to receive and retain a planar member

The present invention provides a construction support device comprising a first support unit comprising a first center and a connector recess disposed in said first center; a second support unit comprising a second center and a connector post extending from said second center where said connector recess is configured to receive said connector post and join said first support unit to said second support unit; said first support unit comprises a plurality of lower sections extending radially from said first center and said plurality of lower sections are spaced apart to provide a plurality of lower grooves and said plurality of lower grooves are configured to receive and retain a planar member; said second support unit comprises a plurality of upper sections extending radially from said second center and said plurality of upper sections are spaced apart to provide a plurality of upper grooves and said plurality of upper grooves are configured to receive and retain a planar member; and said plurality of lower grooves are sinuate.

It is a further aspect of the invention to provide a building system kit comprising planar stackable members, a plurality of construction support devices, and instructions for assembling one or more structures. The present invention provides A card construction game and teaching tool for building a structure of cards, comprising: a plurality of cards; at least one construction support device having an outermost cuboid surface; said construction support device comprising a plurality of grooves disposed in space relation along said outermost cuboid surface; said plurality of grooves are oriented so that said at least one construction support device is symmetrical about three mutually orthogonal planes; said plurality of grooves are configured to receive a portion of one of said cards therein; and said plurality of grooves comprise alternating protrusions configured to releasably engage said portion.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a perspective view of a cubic construction support device in an embodiment of the invention.

FIG. 2 is an exploded view of a cubic construction support device in an embodiment of the invention.

FIG. 3 is a top view of a cubic construction support device in an embodiment of the invention.

FIG. 4 is a perspective view of two cubic construction support devices interfaced with two planar members contacting edge to face.

FIG. 5 is a perspective view of two cubic construction support devices interfaced with two planar members spaced apart edge to face.

FIG. 6 is a perspective view of a cubic construction support device interfaced with two planar members as part of a four card cell.

FIG. 7 is a perspective view of cubic construction support devices and planar members in use with a kit to create a structure.

FIG. 8 is a perspective view of three cubic construction support devices and three planar structures combined to create a structure.

FIG. 9 is a perspective view of multiple cubic construction support devices and planar members combined to create a structure.

FIG. 10 is a perspective view of a spheric construction support device in an embodiment of the invention.

FIG. 11 is an exploded view of a spheric construction support device in an embodiment of the invention.

FIG. 12 is a perspective view of a spheric construction support device interfaced with five planar members to create a structure.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

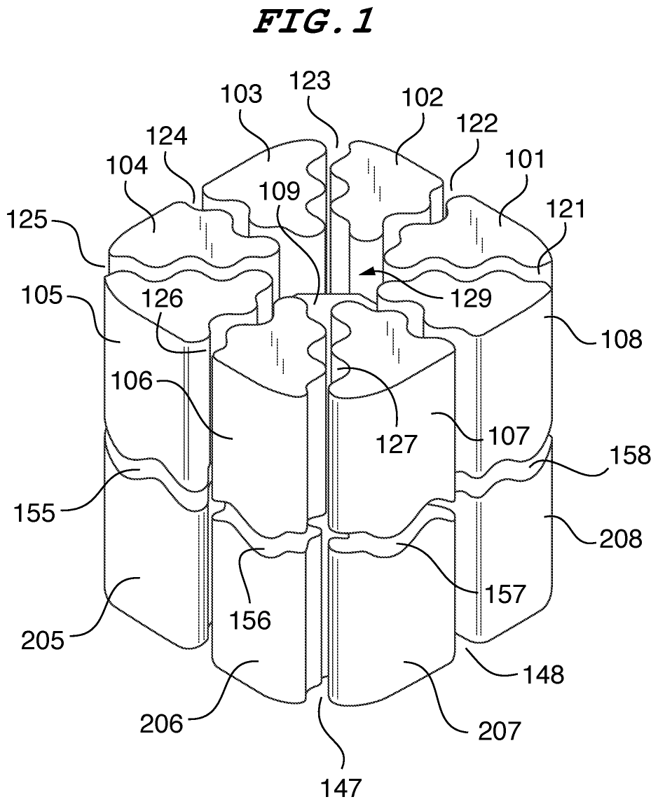

The construction support device of the invention can be provided in different embodiments presenting different geometric shapes. The present invention provides a method to effectively re-purpose unused excess cards. A first embodiment provides a cubic construction support device 100 where the cross section of the device is generally square. A second embodiment of the invention provides a spheric construction support device 400 where the cross section of the device is generally circular. FIG. 1 presents a perspective view of a cubic construction support device 100 in an embodiment of the invention. In a cubic embodiment, the sides can be generally square with sides of equal lengths, or somewhat uneven lengths presenting rectangular cross sections within the spirit of the cubic construction support device 100 embodiment. Numerous grooves are disposed on the device 100. In an embodiment, first upper groove 121 comprises a sinuate path shown extending from central opening 129; first upper groove can be sinuate with a wavy or scalloped interior surface. Central opening 129 provides a void space and connects the openings of the upper grooves and allows for a planar member to be inserted into first upper groove 121, central opening 129, and for example fifth upper groove 125 at the same time. The interior surface can be crenellated with complimentary protrusions on each side of the interior surface to increase retention of an inserted planar member. A construction support device can comprise a plurality of grooves that present sinuate openings at the exterior of the device suited for releasably receiving a planar member. Numerous sinuate grooves can be present in each construction support device oriented along various axes to provide insertion of planar members in different directions to achieve various structures. Uneven interior protrusions mesial to the sinuate grooves provide for improved retention of inserted planar members. The construction support device of the invention can be formed of a flexible material and can comprise a structure configured to flex or hinge to increase or decrease the available opening of the sinuate grooves to accept or retain more than one planar member.

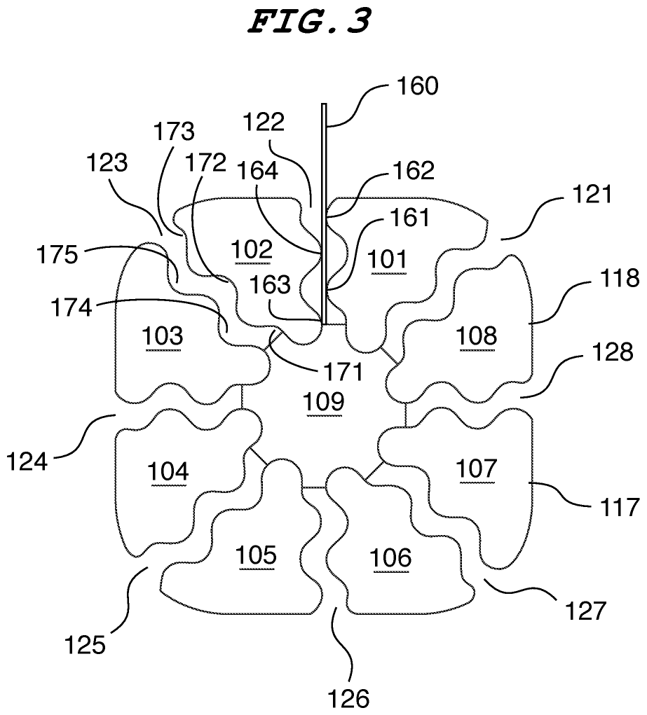

Corresponding sinuate edges of the upper sections present an alternating protrusion and recess configuration suited to receive and retain an inserted planar member as shown in FIG. 3. On a given sinuate edge of an upper section, protrusions and recesses alternate. The corresponding protrusions and recesses create a sinuate groove such as first upper groove 121. First upper section 101 is defined on one side by first upper groove 121 and on a second side, second upper groove 122. The appearance of the interior of first upper groove 121 presents corresponding or complimentary protrusions and recesses. Where one side of second upper groove 122 presents a protrusion of first upper section 101, a corresponding recess is present on the surface of second upper section 102. Several complimentary protrusions and recesses can create a crenellated surface on the interior of each upper and lower groove of the device. Additional grooves are shown and are configured to receive a planar member 160 shown in FIG. 3. A portion of the planar member 160, for example a playing card, is shown inserted. A small portion of the planar member can be inserted so that the construction support device appears as a support and allows most of the planar member to be displayed and viewed. Protrusion 161 of first upper section 101 is shown contacting planar member 160 and protrusion 162 contacts planar member 160. Protrusion 163 and protrusion 164 are disposed on second upper section 102 in second upper groove 122. Third upper groove 123, fourth upper groove 124, fifth upper groove 125, sixth upper groove 126, seventh upper groove 127, and eighth upper groove 128 are shown arrayed about central opening 129 in FIG. 1. In FIG. 3 recess 171, recess 172, and recess 173 are disposed on second upper section 102 to form part of the sinuate path of third upper groove 123. On the opposite side of third upper groove 123, additional recesses, recess 174 and recess 175, are disposed on third upper section 103 corresponding or complimenting the protrusions formed on second upper section 102 to create the sinuate path of third upper groove 123. The numbered protrusions in second upper groove 122 and the numbered recesses in third upper groove 123 are proximate and corresponding to create the path shown in the figures. Each of these plurality of grooves is configured to receive one or more planar members 160 of varying thickness. First upper section 101, second upper section 102, third upper section 103, fourth upper section 104, fifth upper section 105, sixth upper section 106, seventh upper section 107, and eighth upper section 108 (the upper sections) can be molded to extend from center 109 and can be molded to be able to flex slightly to accommodate different thicknesses or multiple layered planar members. The width of the opening of upper grooves can be selected to match the width of a given planar member, for example a playing card. For example, if first upper section 101 is smaller in size it leaves a larger void or opening for first upper groove 121 and second upper groove 122. In addition, sections such as first upper section 101 can flex or move towards first upper groove 121 or second upper groove 122 to enlarge or contract the available space for insertion of a planar member. A polymer plastic can be used for constructing the device of the invention. Alternately a flexible material can be used to provide additional flexibility in receiving planar members such as, but not limited to, foam or rubber.

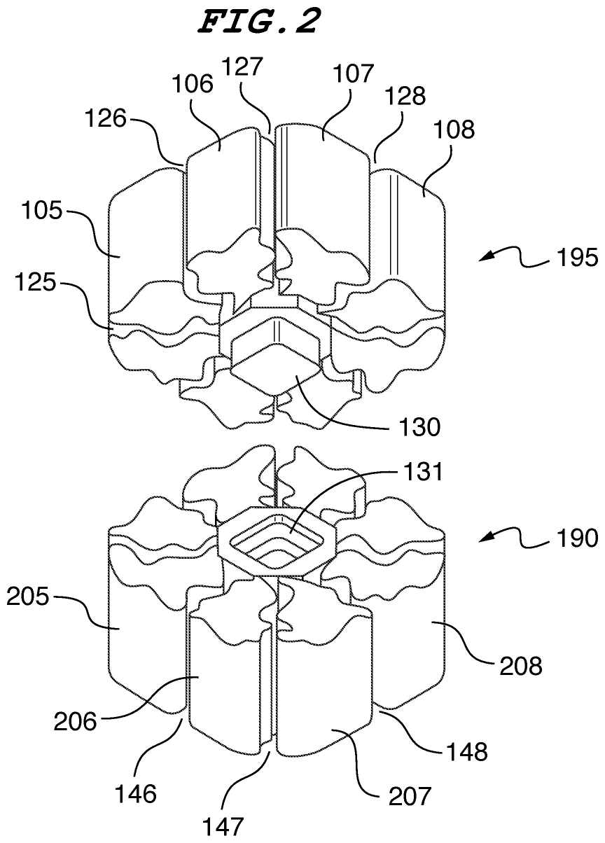

In an embodiment of the invention, cubic construction support device 100 can be configured to be separable comprising first support unit 190 and second support unit 195. As shown in FIG. 2, connector post 130 can be configured to be removably inserted into a connector recess 131 by friction fit. First support unit 190 can comprise additional grooves such as first lower groove 146, second lower groove 147 and third lower groove 148. Additional lower grooves, eight in total, are shown, but not all are numbered. First support unit 190 can be rotated with respect to second support unit 195. First support unit 190 can be configured with the same number of lower sections as the number of upper sections of second support unit 195 and they can be configured in substantially the same way or the lower sections of first support unit 190 can be formed as a mirror image of the upper sections of second support unit 195. Additional openings are provided, for example between upper section 106 and lower section 206 to form medial groove 156 shown in FIG. 1. Lower section 205, lower section 207 and lower section 208 are shown as part of first support unit 190. Additional lower sections are shown but not numbered. Medial groove 155, and medial groove 157, and medial groove 158 can be similarly formed between first support unit 190 and second support unit 180. The medial grooves can be sinuate and formed with the same corresponding protrusion and recess configuration as present in, for example, second upper groove 122.

FIG. 2 presents an exploded view highlighting connector post 130. First support unit 190 can be formed with lower sections comprising corresponding sinuate edges to form the medial grooves shown in FIG. 1. First support unit 190 is preferably formed with the same number of sections as shown in second support unit 195. In the embodiment shown in FIGS. 1 through 4, each support unit comprises eight sections. As shown, each section comprises a sinuate edge on three sides corresponding with the adjacent section to form a sinuate groove such as sixth upper groove 126 or medial groove 156. Sixth upper groove 126 is formed by adjacent sections 105 and 106. Medial groove 156 is shown formed by upper section 106 and lower section 206. Each upper section and each lower section can be formed with the same configuration of a medial sinuate edge so that first support unit 190 can be rotated relative to second support unit 195, and each medial groove will be sinuate and formed between an upper section and a lower section. FIG. 2 presents an embodiment of the invention where two support units can be combined into a single support device and attached together with connector post 130 by insertion into a connector recess 131 centrally disposed in first support unit 190.

FIG. 3 shows a top view of second support unit 195. Center 109 is shown joined to the structures of upper sections 101 through 108. The amount of structural connection between the sections and center 109 can be increased or decreased to reduce or increase the movement of first upper section 101 relative to second upper section 102 and eighth upper section 108. Each upper section 101 through 108 is shown extending outward from center 109 and the corresponding structures of the sections form the upper grooves 121 through 128. Protrusions and recesses are alternating to each other on a given section. In an embodiment of the invention, each protrusion has a corresponding recess formed on the opposite side of each groove. For example, protrusion 161 of first upper section 101 is positioned across from a corresponding recess in second upper section 102. Protrusion 164 of second upper section 102 is positioned across from a corresponding recess in first upper section 101. Flat outer surface 118 is shown on the exterior of eighth upper section 108. Flat outer surface 117 is shown on the exterior of seventh upper section 107 to provide part of a cubic exterior.

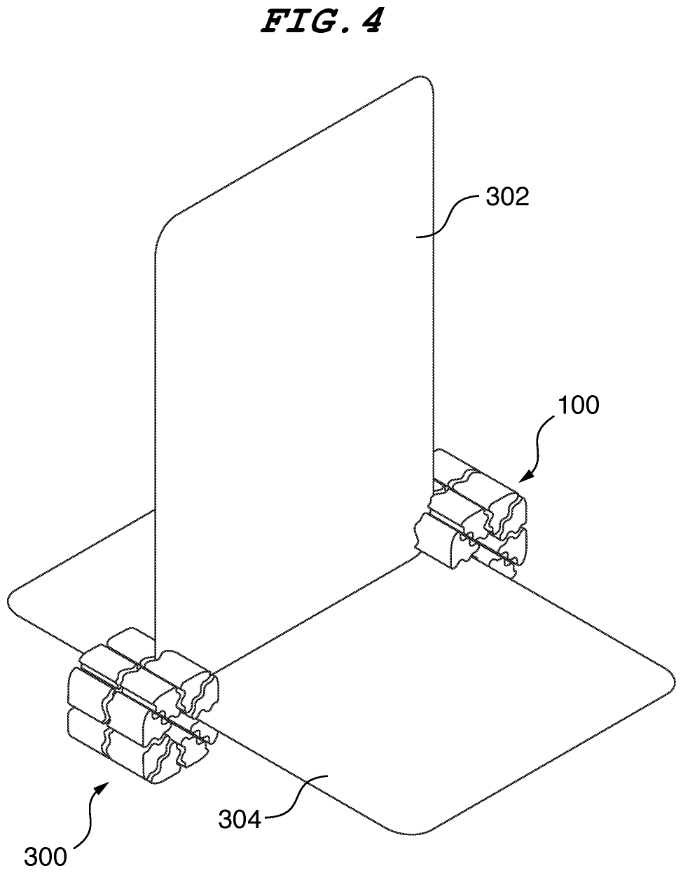

FIG. 4 shows a first construction support device 100 and a second construction support device 300 connected to planar member 302 and planar member 304. In this example of the device of the invention in use, the planar members are playing cards. By inserting a planar member 304 through construction support device 100 and construction support device 300 along a first horizontal axis, and inserting a planar member 302 into device 100 and device 300 along a vertical axis, the planar members 302 and 304 are held and retained in edge to face configuration. The two planar members are touching. Planar member 304 is inserted into an upper groove and a lower groove of each of the cubic construction support devices 100 and 300. Planar member 302 is inserted into a medial groove of device 300 and a medial groove of device 100. Planar members can also be inserted into construction support devices to present a wall or continuous surface of planar members.

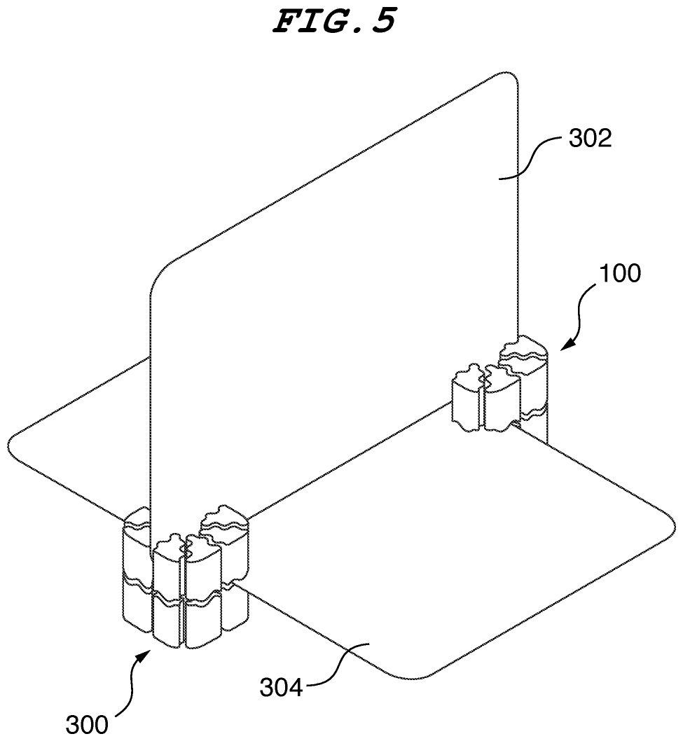

In FIG. 5, the planar members are connected in an alternate configuration. Planar member 302 is inserted into construction support device 100 and construction support device 300 along its longer side, and is prevented from full insertion by the center of the construction support device 100 by contact with center 109 shown in FIG. 3. Planar member 302 is present in two upper grooves of construction support device 100, for example fourth upper groove 124 and eighth upper groove 128 of FIG. 1, and is inserted into two upper grooves of construction support device 300. Importantly, the symmetry of this embodiment of cubic construction support device 100 allows this construction to be completed while the device is rotated 90 degrees in each of the three axes of rotation. As shown in later figures, additional planar members can be inserted and retained in different planes or positions. In this utilization, planar member 302 is not contacting planar member 304.

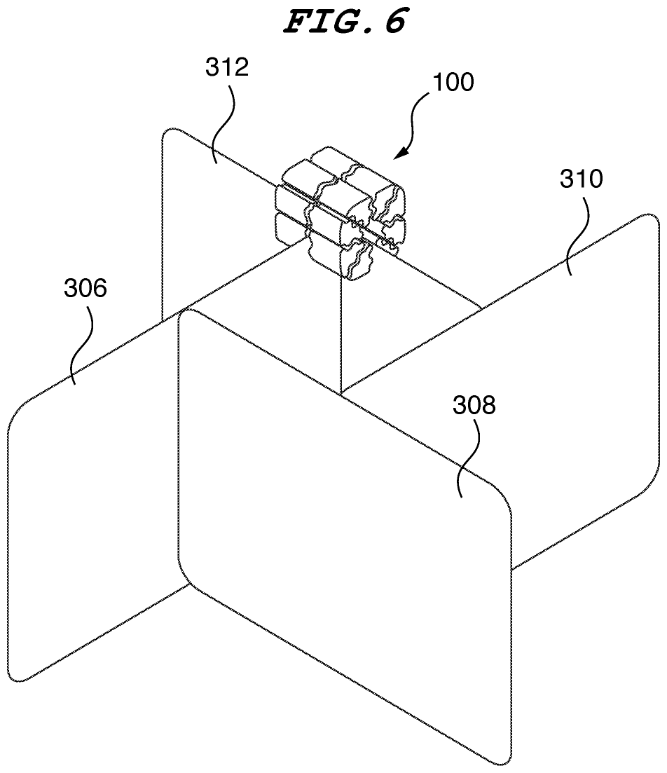

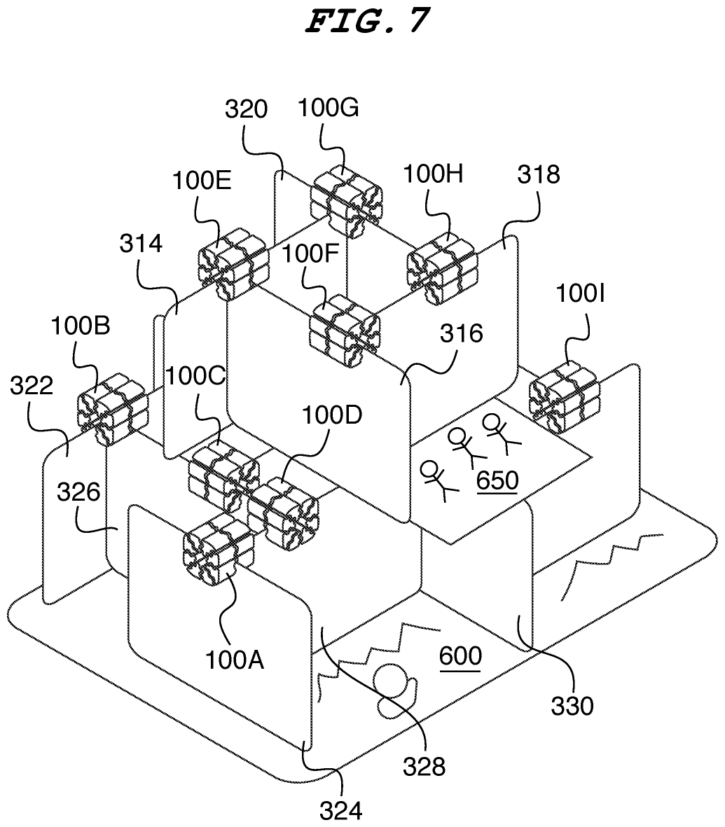

In FIG. 6, planar members 306 and 312 are inserted into cubic construction support device 100 in edge to face contact. While the cards can be inserted in numerous different orientations, planar member 312 is inserted into an upper groove and lower groove while planar member 306 is inserted into a medial groove. Game cards can be used for planar members 306, 308, 310, and 312 and positioned with the short edge of one planar member in contact with the planar surface face of another planar member, simultaneously positioned perpendicularly to each other by the short edge, with both planar members positioned perpendicularly to a table surface contacted by the long edges of the planar members. By inserting a planar member 312 through support device 100 and inserting a planar member 306 into device 100 along a vertical axis, the two planar members are held and retained in edge to face configuration. The two planar members are touching in this utilization. In an alternate configuration (not shown), planar members 306, 308, 310, and 312 can each be rotated 90 degrees from the configuration shown in FIG. 7 with the long edge of one planar member in contact with the planar surface face of another planar member. In the alternate utilization, one planar member is positioned perpendicularly to the other by the long edge, with both planar members positioned perpendicularly to a surface upon which they are built, contacting the surface by the short edges of the planar members or playing cards. In the latter utilization, a greater height of constructing stackable planar members is achieved with the long edge extending upward. FIG. 6 presents a method of constructing planar stackable members into a four-card offset perpendicular T-shaped cell. Each card is shown at a right angle to the contacted card and making edge to face contact with and perpendicular to another card. In alternate utilizations, more cubic construction support devices can be used, for example one at each card contact point.

FIG. 7 shows a number of construction support devices numbered 100A through 100I in use in an embodiment of the invention. Numerous cards are used as planar members 314, 316, 318, 320, 322, 324, 326, 328, 330 to build a structure. Various upper and lower grooves, as well as medial grooves, are utilized to create the structure. In addition, paper, and other planar members are shown that depict a scene or design. Base 600 is shown presenting an elementary background element upon which the structure is constructed. In an embodiment of the invention, the support devices 100A through 100I are provided in a kit with instructions and preprinted scenes to facilitate the building of a structure with a particular purpose to facilitate imaginative play, and highlighting the display of various cards such as collectible or tradable cards. Floor 650 is included as a horizontal structure that facilitates construction of a building e.g., a castle, fort, or house.

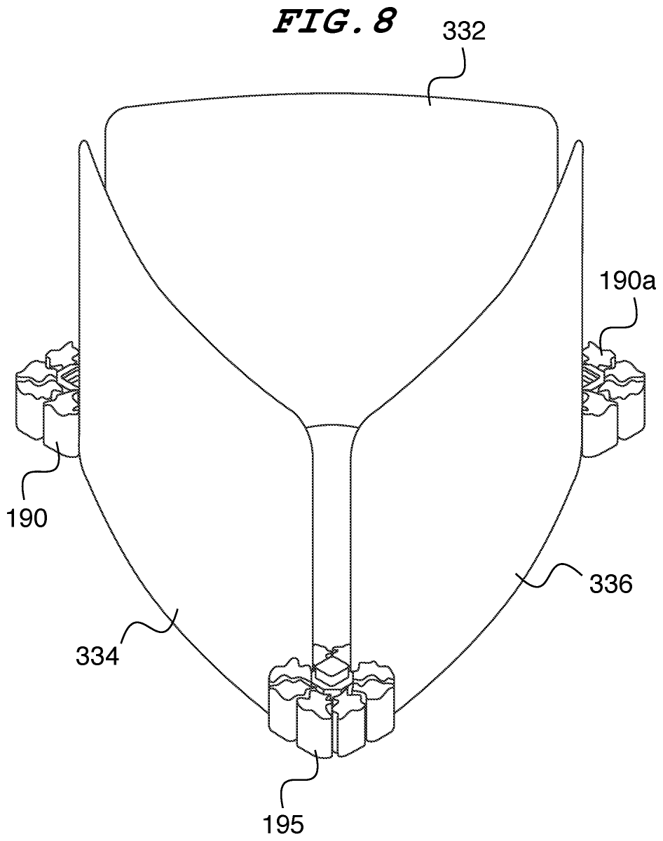

FIG. 8 displays how a single unit such as first support unit 190 can be utilized to connect to opposing sides of a single planar stackable member, thereby allowing the planar member to be held and maintained in an upright position, with long edge positioned perpendicularly to a table surface upon which it is built. FIG. 8 shows planar member 332, planar member 334, and planar member 336 assembled with the use of first support unit 190, second support unit 195, and third support unit 190A which can be identical to first support unit 190. Planar member 332 is inserted into first support unit 190 and second support unit 195. Planar member 334 is inserted into first support unit 190 and third support unit 190A. Planar member 336 is inserted into third support unit 190A and second support unit 195. Referring to FIG. 3, a planar member inserted into first upper groove 121 would be oriented about 45 degrees from a planar member inserted into second upper groove 122. Inserting planar members into first upper groove 121 and third upper groove 123 would direct a planar member at angle offset of 90 degrees, but can be tensioned into a 60 degree angle to form the triangle configuration of FIG. 8. The structure of FIG. 6 and FIG. 8 and other structures can be repeated and combined with other structures to form a tall structure or a wide structure and various combinations of support units and planar members can be utilized in the spirit of the invention.

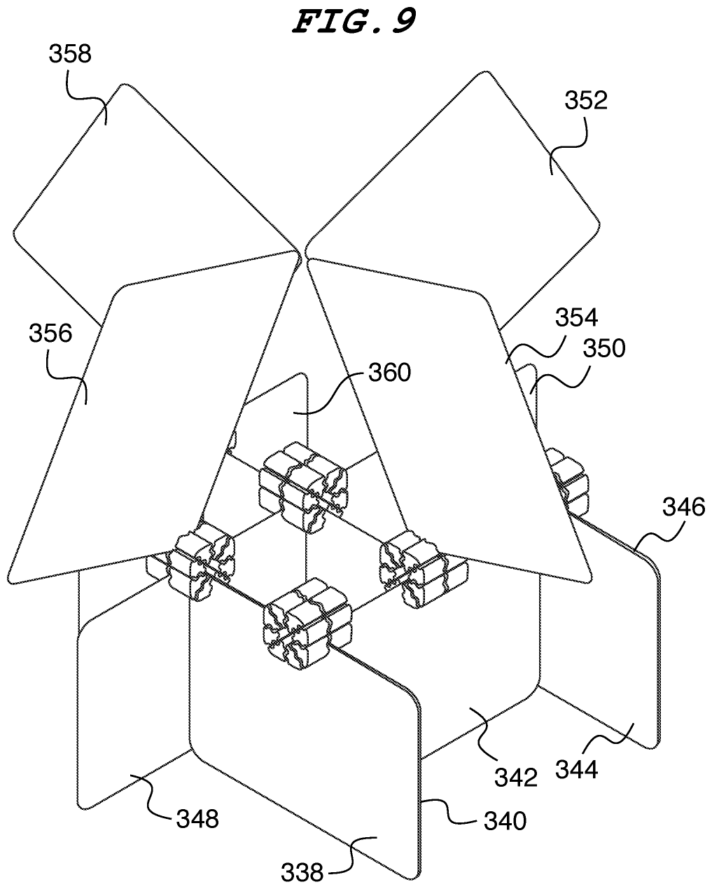

FIG. 9 shows a number of cubic construction support devices 100 in use in an embodiment of the invention. Numerous game cards are used as planar members 338, 340, 342, 344, 346, 348, 350, 352, 354, 356, 358, 360 to build a structure. FIG. 9 shows how, in such a configuration and position, a sloping design aesthetic can be produced using slanted or tilted planar member 352, 354, 356, 358 that are inserted diagonally, by corners, into multiple construction support devices (not numbered). This configuration allows building sloped components, for example a steeple. Multiple planar members can be inserted in the same groove of the support device, for example planar member 338 and planar member 340 are inserted into the same groove. Planar member 344 and planar member 346 are inserted into the same groove. Additional planar members can be added to increase strength or stability to a structure. Placing more than one planar member into a single groove can provide greater strength, support, and stability to a structure. Utilizing multiple planar members can enable greater structural integrity and construction heights to be achieved and maintained.

The weight a cubic construction support device 100 in an embodiment of the present invention can be approximately 5 to 10 grams. The density of the material selected for the device in combination with the volume determine the weight. In a preferred embodiment, the device 100 is molded out of a plastic material having a density of about 1.2 grams per cubic centimeter and general dimensions of about 20 mm square. Larger and smaller embodiments are contemplated in the spirit of the invention, for example 5 mm square to 50 mm square. Thermoplastics can be utilized to mold the materials or filaments can be utilized to extrude or 3D print devices in an embodiment of the invention. In a particular embodiment a thermoplastic polyurethane (TPU) filament was utilized with a Shore hardness of 90 A. Other foam and solid plastics can be utilized in the spirit of the invention. The weight or mass of the embodiments of the device add inertia and stability to increase the strength and resilience of a structure constructed with the devices of the invention. Embodiments of the invention can weigh several grams and, in the aggregate, can add mass and inertia to a structure and aid in resistance to moving or shifting. The additional mass added to a house of cards helps the structure resist falling or failing.

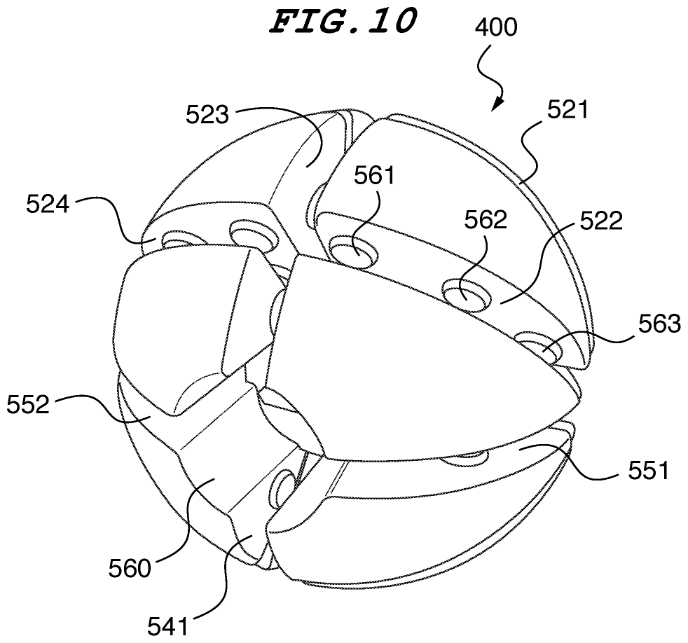

FIG. 10 presents a perspective view of a spheric construction support device 400 in an embodiment of the invention. First upper groove 521, second upper groove 522, third upper groove 523, and fourth upper groove 524 shown with raised protrusions interior to each groove to improve retention of an inserted member. The protrusions can be formed on one side or on each side of the groove and positioned offset from each other to provide a sinuate path for insertion of a planar member. Whereas the embodiment of the cubic construction support device 100 presented sinuate grooves that are formed with sections comprising sinuate edges, the spheric construction support device 400 presents a different approach to creating the grooves that retain a planar member. The embodiment of FIG. 10 presents first raised protrusion 561, second raised protrusion 562, and third raised protrusion 563 disposed in second upper groove 522. In this particular embodiment first raised protrusion 561 is circular in shape; other shapes can be employed in the spirit of the invention. Each approach to the sinuate grooves can be employed in construction support devices of various shapes, for example cubic, spheric, or other shapes. Medial groove 551 and medial groove 552 are shown traversing the center of the device. First lower groove 541 is configured to receive planar member. Socket 560 is a larger opening suited for receiving a ball and socket connector, not shown. A rod terminating in a ball can be inserted in socket 560. A rod terminating in a ball on each end can be inserted into two sockets 560 on two spheric construction support devices so that they can be connected, swiveled, and rotatably adjusted in relation to each other.

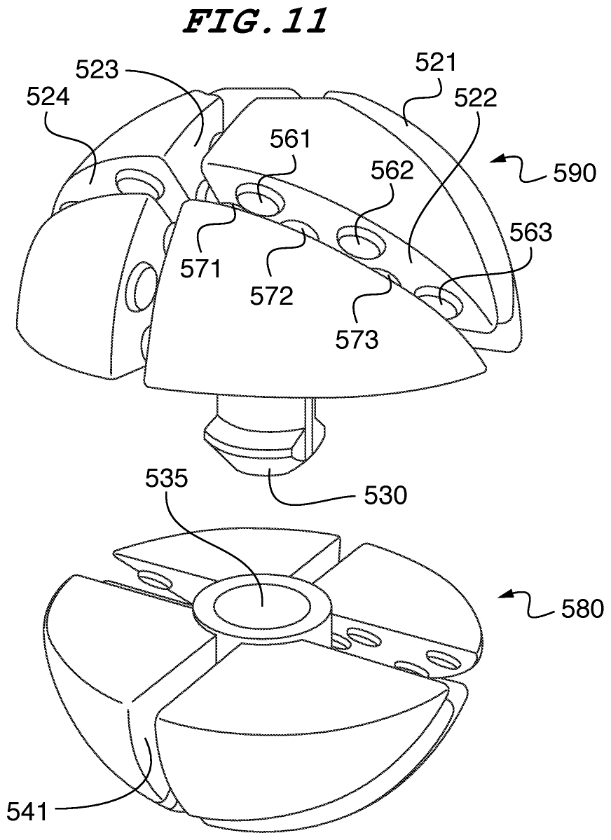

FIG. 11 presents an exploded view of a spheric construction support device in an embodiment of the invention comprising two halves. First support unit 580 is configured for removable attachment to second support unit 590 by insertion of connector post 530 to connector recess 535. Second support unit 590 comprises grooves for receiving planar members. First upper groove 521 is configured to receive a planar member. Fourth upper groove 524 is configured for receiving a planar member in a direction perpendicular to third upper groove 523. First support unit 580 comprises additional grooves for receiving planar members in different orientations. First lower groove 541 and additional lower grooves, not numbered, can be provided in first support unit 580 similar to the grooves on second support unit 590 as shown and can receive a planar member that can be inserted until it abuts the structure of connector recess 535. A planar member can be inserted across the entire device 500 by insertion into, for example upper groove 523 that does not impinge upon the center of the device 400. Sections, not numbered form the structure and border of the upper grooves, lower grooves, and medial grooves. Second upper groove 522 is shown with first raised protrusion 561, second raised protrusion 562, and third raised protrusion 563 disposed in second upper groove 522. On the opposite wall, fourth raised protrusion 571, fifth raised protrusion 572, and sixth raised protrusion 573 are shown offset from the corresponding protrusions on the opposite wall of second upper groove 522. The overall void space between the sections is linear with the borders of the sections formed in a straight line, while the interior is configured with offset protrusions to create a sinuate path.

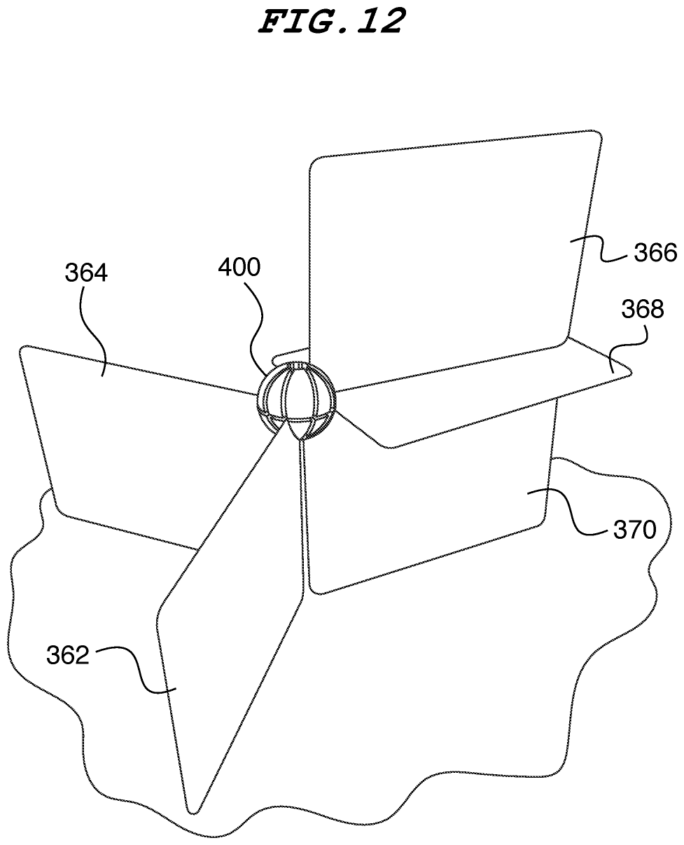

FIG. 12 presents a spheric construction support device 400 in an embodiment of the invention connected to planar members to create a structure. A spheric construction support device 400 is connected to numerous planar members presented as playing cards to create a structure. Planar members 362, 364, 366, 368, and 370 are shown connected to the single spheric construction support device 400 to illustrate the number of planar members that can be inserted and supported to build a structure. Upper and lower grooves, as well as medial grooves, are utilized to create the structure. Paper, and other planar members can be utilized to depict a scene or design as well as build a structure. In an embodiment of the invention, spheric construction support device 400 can be provided in a kit with instructions and preprinted scenes to facilitate the building of a structure with a particular purpose to facilitate imaginative play, and highlighting the display of various cards such as collectible or tradable cards.

In addition to the embodiments shown herein, products in the spirit of the invention may be provided as a part of a building system comprising the support device presented in various shapes, sizes, and images, thereon that may be built into a particular item—most preferably, a horizontal or vertical building or structure. In general, the planar stackable members with which this invention are concerned will be made from paper, cardboard or plastic having a thickness of a fraction of a millimeter. However, larger and thicker cards or planar stackable members can be accommodated by simply making larger connectors. Playing cards can have a thickness that typically ranges from 0.17 mm to 0.24 mm.

The present invention provides features to allow one card, which is connected to the planar surface of an adjoining card, the freedom of movement to be moved freely, albeit controlled, across the full face of an adjoining card so as to provide multiple possibilities for positioning.

As shown in the Figures, the construction support device 100 can be used as a whole piece, or utilized in a portion such as second support unit 195, alone. Second support unit 195 and first support unit 190 can each be comprised of different colors and texture finishes which, when assembled together to form a whole piece, can be interchanged to provide a number of different visually aesthetic variations presented by the entire cube. For example, the second support unit 195 can be made of a blue color and a glossy texture finish, while the first support unit 190 can be made of a yellow color and a matte or satin texture finish. When each respective half is joined together, the resulting cube would comprise a construction support device 100 that would have a second support unit 195 of a blue color and a glossy texture finish, while the first support unit 190 would have a yellow color and matte or satin texture finish. In addition, when a construction support device 100 is separated into a second support unit 195 and first support unit 190, both the second support unit 195 and the first support unit 190 can be adopted and inserted into a pre-configured base 600 or a foundation surface mat whereby planar members can be inserted into second support unit 195 and first support unit 190 in order to form a steady support foundation for stacking planar members. The receiving base 600 can comprise a base tray or a foundation mat and can comprise openings suited for friction fit engagement of a cubic construction support device 100 or a spheric construction support device 400, or half sections of either embodiment, including second support unit 195 or first support unit 580. As shown in FIG. 8, a planar member can be inserted into a second support unit 195 to retain the planar member in a vertical position and can be combined with other base 600 openings and support devices to establish a base or foundation of planar members to create any structure or follow instructions and preplanned materials to create a particular structure such as a castle or fort with preprinted materials for walls or floors, etc.

The present disclosure relates generally to toy, game, or puzzle building pieces, and, more particularly, to various shaped connection devices adaptable to support construction in a multitude of configurations and angles. The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A construction support device comprising:
a plurality of sections projecting radially outward from a solid center;
said plurality of sections each comprise sinuate edges; and
said plurality of sections are spaced apart from adjacent sections to create a plurality of sinuate grooves configured to receive and retain a planar member.

2. The construction support device of claim 1 wherein said plurality of sinuate grooves comprises a corresponding protrusion and a corresponding recess disposed on opposite sides of each of said plurality of sinuate grooves.

3. The construction support device of claim 2 wherein each of said plurality of sections comprises a flat outer surface to provide a cubic exterior.

4. The construction support device of claim 3 further comprising a central opening disposed centrally to said plurality of sinuate grooves and providing a void space in communication with said plurality of sinuate grooves.

5. The construction support device of claim 4 wherein said plurality of sections comprises four or more sections and said plurality of sinuate grooves comprises four or more sinuate grooves.

6. The construction support device of claim 5 wherein said plurality of sections comprises eight sections and said plurality of sinuate grooves comprises eight sinuate grooves radiating outward in different directions from said central opening.

7. The construction support device of claim 1 wherein each of said plurality of sections comprises a round outer surface to provide a spheric exterior.

8. The construction support device of claim 7 wherein said plurality of sinuate grooves is formed by alternating protrusions disposed on said plurality of sections.

9. A construction support device comprising:
A first support unit comprising a first center and a connector recess disposed in said first center;
A second support unit comprising a second center and a connector post extending from said second center where said connector recess is configured to receive said connector post and join said first support unit to said second support unit;
said first support unit comprises a plurality of lower sections extending radially from said first center and said plurality of lower sections are spaced apart to provide a plurality of lower grooves and said plurality of lower grooves are configured to receive and retain a planar member;
said second support unit comprises a plurality of upper sections extending radially from said second center and said plurality of upper sections are spaced apart to provide a plurality of upper grooves and said plurality of upper grooves are configured to receive and retain a planar member; and
said plurality of lower grooves are sinuate.

10. The construction support device of claim 9 wherein said plurality of lower grooves comprises a first sinuate lower groove, a second sinuate lower groove, a third sinuate lower groove, and a fourth sinuate lower groove;
said first sinuate lower groove is defined by a first lower section and a second lower section, said second sinuate lower groove is defined by said second lower section and a third lower section, said third lower sinuate groove is defined by said third lower section and a fourth lower section, said fourth sinuate lower groove is defined by said fourth lower section and said first lower section; and
said each of said lower sections comprises a first sinuate edge and a second sinuate edge.

11. The construction support device of claim 10 wherein each of the plurality of upper sections comprises a first sinuate edge and a second sinuate edge that define said plurality of upper grooves.

12. The construction support device of claim 10 wherein:
each upper section comprises a sinuate medial edge;
each lower section comprises a sinuate medial edge;
adjacent sections define opposite edges of a medial groove; and
said first support unit can be rotated relative to said second support unit to position an upper section adjacent a lower section to create a medial groove that is consistently configured in multiple positions of rotation.

13. The construction support device of claim 9 wherein said first sinuate lower groove extends from said first center in a first direction, said second sinuate lower groove extends from said first center in a second direction, said third sinuate lower groove extends from said first center in a third direction, and said fourth sinuate lower groove extends from said first center in a fourth direction.

14. The device of claim 13 wherein each sinuate lower groove comprises at least two sinuate borders configured to correspond with an adjacent section;
each sinuate border comprises at least two protrusions and at least one recess disposed between said at least two protrusions; and
said at least two protrusions of each sinuate border are configured to contact an inserted planar member.

15. A card construction game and teaching tool for building a structure of cards, comprising:
a plurality of cards;
at least one construction support device having an outermost cuboid surface;
said construction support device comprising a plurality of grooves disposed in space relation along said outermost cuboid surface;
said plurality of grooves are oriented so that said at least one construction support device is symmetrical about three mutually orthogonal planes;
said plurality of grooves are configured to receive a portion of one of said cards therein; and
said plurality of grooves comprise alternating protrusions configured to releasably engage said portion.

16. The card construction game and teaching tool for building a structure of cards of claim 15 wherein said construction support device comprises a central opening allowing said portion to be positioned within a first sinuate groove, a second sinuate groove, and said central opening simultaneously.

17. The card construction game and teaching tool for building a structure of cards of claim 16 wherein said construction support device comprises a first unit and a second unit and a medial groove positioned between said first unit and said second unit.

18. The card construction game and teaching tool for building a structure of cards of claim 17 wherein said plurality of grooves are crenellated by said alternating protrusions and alternating recesses.

19. The card construction game and teaching tool for building a structure of cards of claim 15 wherein said plurality of grooves are sinuate.
